(19) United States
(12) Patent Application Publication
(10) Pub. No.: US 2015/0354018 A1
(43) Pub. Date: Dec. 10, 2015

(54) METHOD FOR PRODUCING CONCENTRATED SACCHARIFIED SOLUTION

(71) Applicant: KAWASAKI JUKOGYO KABUSHIKI KAISHA, Kobe-shi, Hyogo (JP)

(72) Inventors: Takashi NISHINO, Suita-shi (JP); Noriaki IZUMI, Kobe-shi (JP); Hironori TAJIRI, Kobe-shi (JP); Hiromasa KUSUDA, Kobe-shi (JP); Masaki TSUZAWA, Kobe-shi (JP)

(21) Appl. No.: 14/758,286

(22) PCT Filed: Dec. 3, 2013
(86) PCT No.: PCT/JP2013/007087

§ 371 Date: Jun. 29, 2015

(30) Foreign Application Priority Data
Dec. 28, 2012 (JP) 2012-287177

(51) Int. Cl. C13K 1/04; B01D 61/02

(52) U.S. Cl. CPC C13K 1/04; B01D 61/025; B01D 61/027

(57) ABSTRACT

A method for producing a concentrated saccharified solution using lignocellulosic biomass as a source material. The method includes filtering a saccharified solution obtained by hydrolysis of cellulosic biomass through a membrane separator having a separation membrane having a molecular cutoff ranging from 1000 or more and 7000 or less, and feeding it to a reverse osmosis membrane device to concentrate the same. By such treatment, the saccharides having small molecular weights contained in the saccharified solution are transferred to the filtrate, and the lignin and its decomposition product having large molecular weights are drained as a concentrated solution from the membrane separator. Accordingly, it is possible to prevent loss of saccharides contained in the saccharified solution, and to easily prevent occurrence of fouling in the reverse osmosis membrane used in concentration of the saccharified solution.

### TECHNICAL FIELD

The present invention relates to a method for producing a concentrated saccharified solution featured by selectively removing a pigment ingredient from a saccharified solution before concentration in a method of producing bioethanol by saccharification (hydrolysis), concentration, fermentation and distillation from hemicellulose or cellulose in lignocellulosic biomass such as wooden biomass or herbal biomass.

### BACKGROUND ART

Lignocellulosic biomass including wooden biomass consists of about 20% of hemicellulose, about 50% of cellulose, and about 30% of lignin. Hemicellulose and cellulose are decomposed into saccharides by a saccharification treatment, and then are fermented by a fermentation microorganism such as yeast, and thus ethanol can be produced. Saccharification of hemicellulose gives C5 saccharides and C6 saccharides, and saccharification of cellulose gives C6 saccharides. Examples of typical saccharification methods of lignocellulosic biomass include a hydrolysis method using strong acid, a hydrolysis method using enzyme, and a hydrolysis method using high temperature and high pressure water in a supercritical state or subcritical state.

The term C5 saccharides used herein refers to pentoses such as xylose or arabinose, and oligosaccharides thereof. The term C6 saccharides used herein refer to hexoses such as glucose or galactose, and oligosaccharides thereof.

Lignin contained in lignocellulosic biomass fails to be hydrolyzed into saccharides, and thus cannot be used as a source material for production of bioethanol. In addition, since lignin covers cellulose or hemicellulose, it inhibits the efficient enzymatic saccharification reaction in the hydrolysis method using an enzyme, and inhibits hydrolysis of cellulose or hemicellulose in the hydrolysis method using acid. On the other hand, also in the hydrolysis method using high temperature and high pressure water, mixing of lignin and its decomposition product into the saccharified solution can cause coloring of the saccharified solution or inhibit fermentation in the subsequent fermentation step. Therefore, in the bioethanol production method, it is an important issue to remove lignin and its decomposition product from biomass or a saccharified solution.

Patent document 1 discloses a method of hydrolyzing biomass, and treating the obtained hydrolysate with wooden carbide to remove fermentation inhibitory substances such as furfural, 5-hydroxymethylfurfural, guaiacol or vanillin contained in the hydrolysate.

Patent document 2 discloses discharging and removing fermentation inhibitory substances from biomass by bringing the biomass into contact with aqueous ammonia. Patent document 2 also discloses that solids are removed from a biomass-pretreated solution before the saccharification step by means of drainage, decanting, centrifugation or filtration.

### CITATION LIST

### Patent Literature

PTL 1: JP 2005-270056 A
PTL 2: JP 2010-536376 A

### SUMMARY OF INVENTION

### Technical Problem

As disclosed in Patent Document 1, the method of removing fermentation inhibitory substances by treating a biomass saccharified solution with an adsorbent such as activated carbon or an ion exchange resin requires high cost for recycling the adsorbent or the ion exchange resin, and the removal rate of fermentation inhibitory substances is not said to be high. Also there is a problem that the adsorbent or the ion exchange resin remain in the saccharified solution, and part of saccharides is adsorbed by the adsorbent or the ion exchange resin, to lead loss of the saccharides.

Further, the saccharified solution that is obtained by the saccharification treatment of biomass is not suited for alcoholic fermentation directly, because of low saccharide concentration. For this reason, it is common to conduct the alcoholic fermentation after increasing the saccharide concentration by concentrating the saccharified solution, however, lignin and its decomposition product not only inhibit fermentation but also cause occurrence of fouling in a reverse osmosis membrane, and are likely to decrease the flux of the reverse osmosis membrane. However, it is difficult to remove the lignin and its decomposition product by an adsorbent such as activated carbon or an ion exchange resin.

When fouling occurs in the reverse osmosis membrane, the necessity of washing with a chemical solution such as a citric acid aqueous solution or a caustic soda aqueous solution arises, and the running cost increases. In addition, repeated washings of the reverse osmosis membrane with a chemical solution shorten the service life of the membrane.

It is an object of the present invention to provide a method for producing a concentrated saccharified solution using lignocellulosic biomass as a source material, including a pretreatment method capable of easily removing lignin and its decomposition product contained in the saccharified solution and reducing the load in the step of concentrating the saccharified solution.

### Solution to Problem

As a result of diligent efforts to solve the above problems, the present inventors found that by filtering a biomass saccharified solution with a membrane separator having a separation membrane of a molecular cutoff ranging from 1000 or more and 7000 or less, and feeding the filtrate to a reverse osmosis membrane device or a nanofiltration membrane device, it is possible to easily separate lignin and its decomposition product that have larger molecular weights than the molecular cutoff of the separation membrane and are likely to cause occurrence of fouling in the reverse osmosis membrane or the nanofiltration membrane, from saccharides that have smaller molecular weights than the molecular cutoff of the separation membrane and are suited for alcoholic fermentation, and finally accomplished the present invention.

Concretely, the present invention relates to a method for producing a concentrated saccharified solution, comprising:

a saccharification step of hydrolyzing cellulosic biomass to obtain a saccharified solution;

a filtration step of filtering the saccharified solution by a membrane separator; and

a concentration step of concentrating the filtered saccharified solution by a reverse osmosis membrane device or a nanofiltration membrane device;

wherein the membrane separator is a membrane separator having a separation membrane of a molecular cutoff ranging from 1000 or more and 7000 or less, and

the filtration step is a step of feeding a filtrate of the membrane separator to the reverse osmosis membrane device or the nanofiltration membrane device.

When a filtering treatment is conducted by means of a membrane separator having a separation membrane of a molecular cutoff ranging from 1000 or more and 7000 or less before concentration of the saccharified solution by the reverse osmosis membrane device or the nanofiltration membrane device, lignin and its decomposition product having a larger molecular weight than the molecular cutoff of the separation membrane, which is a pigment ingredient that colors the saccharified solution cannot pass through the separation membrane similarly to solids. On the other hand, saccharides having smaller molecular weights than the molecular cutoff of the separation membrane, and having small molecular weights suited as substrates for alcoholic fermentation are contained in the filtrate. Accordingly, by feeding the filtered saccharified solution to the reverse osmosis membrane device or the nanofiltration membrane device, it is possible to obtain a concentrated saccharified solution that is less likely to cause fouling in the reverse osmosis membrane or the nanofiltration membrane and contains saccharides suited for alcoholic fermentation at high concentration.

### Advantageous Effects of Invention

According to the present invention, it is possible to prevent loss of saccharides contained in the saccharified solution, and to easily prevent occurrence of fouling in the reverse osmosis membrane used in concentration of the saccharified solution.

### BRIEF DESCRIPTION OF DRAWINGS

FIG. 1 is a schematic flowchart of an ethanol production method according to Embodiment 1 of the present invention.

FIG. 2 is a schematic flowchart of an ethanol production method according to Embodiment 2 of the present invention.

FIG. 3 is a schematic flowchart of a conventional ethanol production method using an absorbent.

FIG. 4 is a graph plotting the relationship between the transmission time and the transmission flow rate of the reverse osmosis membrane.

### DESCRIPTION OF EMBODIMENTS

Hereinafter, preferred embodiments of the present invention will be explained in reference to the drawings. The present invention is not limited to the following description.

### Embodiment 1

### Preparation of Source Material Slurry

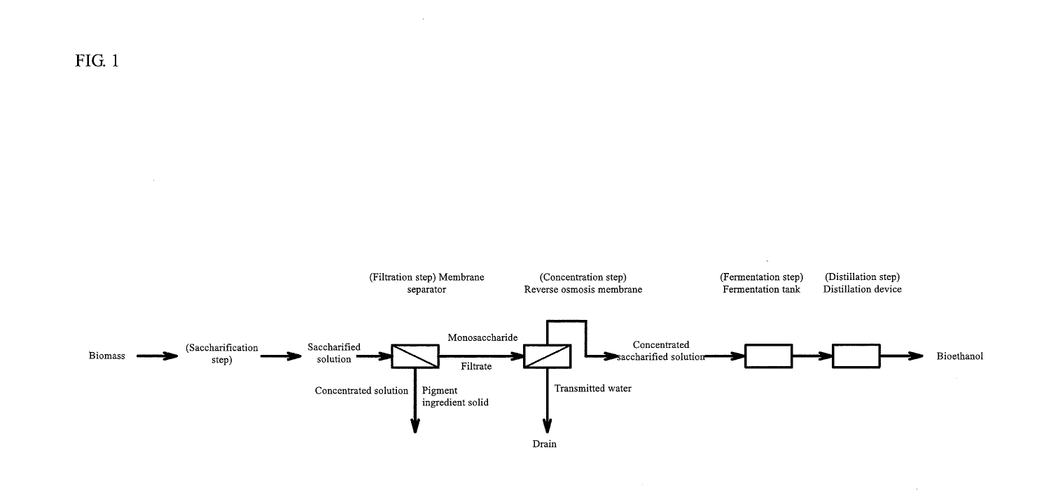

FIG. 1 is a schematic flowchart of an ethanol production method according to Embodiment 1 of the present invention. As a pretreatment, lignocellulosic biomass (vegetation biomass such as bagasse, beet dregs, or straw) is ground to several millimeters or smaller. The ground cellulosic biomass is added with water and stirred to be rendered a slurry. The water content of the prepared source material slurry is preferably adjusted to 50% by mass or more and 95% by mass or less. To the source material slurry, acid such as sulfuric acid, hydrochloric acid, nitric acid, phosphoric acid or acetic acid may be appropriately added as an acid catalyst. In this case, the acid concentration in the source material slurry is preferably adjusted to 0.1% by mass or more and 10% by mass or less.

(Saccharification Step)

The source material slurry is saccharified by a known biomass saccharifying method such as a hydrolysis method using strong acid, a hydrolysis method using an enzyme, or a hydrolysis method using high temperature and high pressure water in a supercritical state or subcritical state, and a biomass saccharified solution is obtained. In the case of the saccharifying method of adding acid or alkali to the source material slurry, it is preferred to neutralize the saccharified solution before the later-described fermentation step. In this context, it is assumed that any saccharides contained in the saccharified solution obtained by the saccharification step are monosaccharides such as glucose.

In the saccharification step of the present invention, it is preferred to solid-liquid separate the biomass saccharified solution by using a solid-liquid separating device such as a screw press, decanter, filter press, vacuum dehydrator or thickener to adjust the solid concentration to 0.1% by mass or less. The saccharified solution whose solid concentration is adjusted to 0.1% by mass or less is transferred to the filtration step.

(Filtration Step)

The saccharified solution is fed to a membrane separator. The membrane separator has a separation membrane of a molecular cutoff ranging from 1000 or more and 7000 or less. While the description will be made for the case where the molecular cutoff is 1000, the same applies to the cases of other molecular cutoffs. Preferably, the molecular cutoff of the separation membrane is selected depending on the mean molecular weight of the saccharides or the pigment ingredient that is calculated from analysis of the saccharified solution obtained in the saccharification step.

Monosaccharides having a molecular weight of less than 1000 pass through the separation membrane and are contained in the filtrate. On the other hand, saccharides having a molecular weight of 1000 or more that are less suited for fermentation, and the pigment ingredient that colors the saccharified solution (lignin and its decomposition product) cannot pass through the separation membrane, and are drained from the upstream side (primary side) of the membrane separator together with the concentrated solution.

The separation membrane is a ultrafiltration membrane (UF membrane) or a nanofiltration membrane (NF membrane). The molecular cutoff of the separation membrane is preferably from 1000 to 7000. The filtrate of the membrane separator from which the suspended matter (solid) has been removed is taken out from the downstream side (secondary side) of the membrane separator, and is fed to the reverse osmosis membrane device (RO membrane device) or the nanofiltration membrane device (NF membrane device) which is a concentrating device.

(Concentration Step)

The saccharified solution fed to the reverse osmosis membrane device or the nanofiltration membrane device is concentrated so that the saccharide concentration is more than or equal to 15% by mass that is suited for alcoholic fermentation. The concentrated saccharified solution (concentrated saccharified solution) is fed to the fermentation tank, and subjected to the fermentation step. On the other hand, the water having passed through the reverse osmosis membrane or the nanofiltration membrane is drained from the downstream side (secondary side) of the reverse osmosis membrane device or the nanofiltration membrane device.

In the present invention, since not only the suspended matter but also lignin and its decomposition product having a molecular weight of 1000 or more which is a pigment ingredient are removed from the saccharified solution fed to the reverse osmosis membrane device or the nanofiltration membrane device, fouling is less likely to occur in the reverse osmosis membrane or the nanofiltration membrane.

(Fermentation Step)

The concentrated saccharified solution in the fermentation tank is fermented by a known brewing method using yeast or an alcoholic fermenting bacterium, and ethanol is produced. After end of the fermentation step, the fermented liquid containing ethanol is fed to the distillation device.

(Distillation Step)

The fermented liquid is distilled in the distillation device and the ethanol is concentrated. The distillate obtained by the distillation step in which ingredients other than the solid and ethanol have been removed is taken out from the distillation device as bioethanol. In the distillation step, a known distillation step that is known as a production method of distilled liquor can be employed.

### Embodiment 2

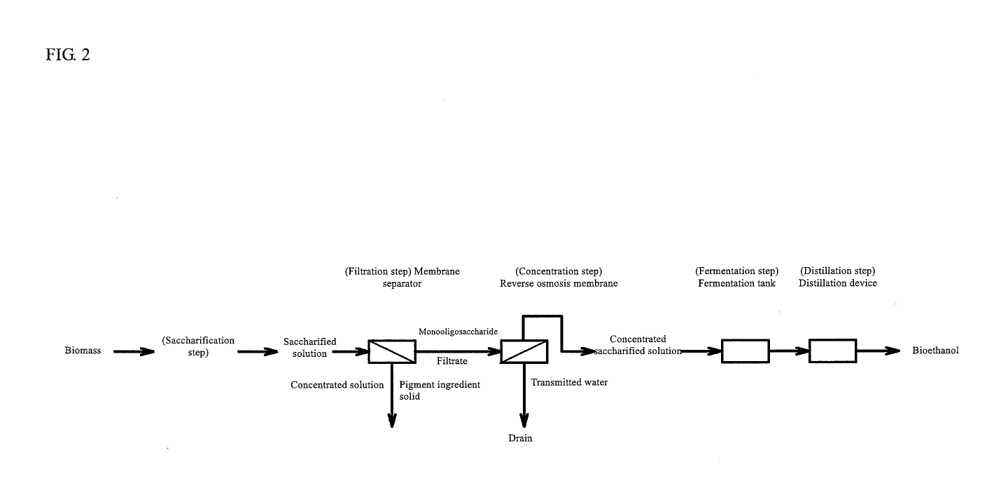

FIG. 2 is a schematic flowchart of an ethanol production method according to Embodiment 2 of the present invention. Embodiment 2 is identical to Embodiment 1 in the configuration and flow except that the saccharified solution obtained by the saccharification step is assumed to contain monosaccharides such as glucose and oligosaccharides having a molecular weight of less than 1000 as the saccharides.

Oligosaccharides having a molecular weight of less than 1000 pass through the separation membrane similarly to monosaccharides, and are contained in the filtrate, which is fed to the fermentation step. The concentrated solution of the membrane separator does not contain monosaccharides and oligosaccharides, but contain lignin and its decomposition product having a molecular weight more than or equal to the molecular cutoff of the separation membrane of 1000, and solids. The concentrated solution of the membrane separator is drained outside the system.

[Conventional Art]

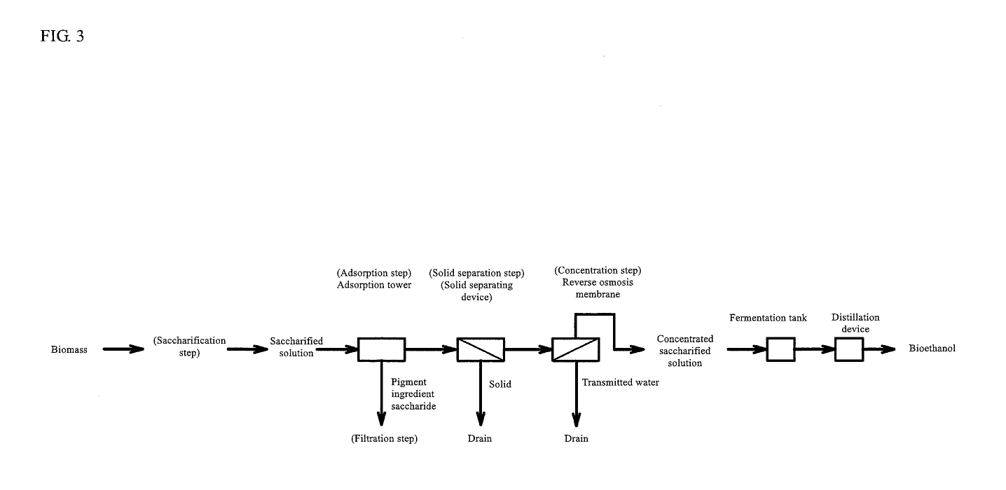

FIG. 3 is a schematic flowchart of a conventional ethanol production method using an absorbent. The method of preparing a saccharified solution, and the steps subsequent to the concentration of the saccharified solution using the reverse osmosis membrane device (or nanofiltration membrane device) are identical to those of Embodiment 1 of the present invention.

(Adsorption Step)

The saccharified solution obtained by the saccharification step is fed to an adsorption tower filled with ion exchange resin or activated carbon. The pigment ingredient (lignin and its decomposition product) contained in the saccharified solution is adsorbed by the ion exchange resin or the activated carbon, and is removed from the saccharified solution. The saccharified solution after the adsorption treatment is subjected to a solid separation step. The adsorption tower from which the saccharified solution has been taken out is regularly supplied with a washing solution (brine in the case of the ion exchange resin; a caustic soda aqueous solution, sulfuric acid or hydrochloric acid in the case of the activated carbon) to wash the ion exchange resin or the activated carbon. At this time, since part of the saccharified solution remains to be adhered to the ion exchange resin or the activated carbon, loss of the saccharides is inevitable. When the adsorption tower is filled with the activated carbon, the activated carbon may be washed by water vapor activation.

(Solid Separation Step)

The saccharified solution fed from the adsorption tower often contains fine solids such as fine powder of ion exchange resin or activated carbon. Therefore, the saccharified solution after the adsorption step is fed to a solid separating device having filter paper, a mesh filter or a filtration membrane having a nominal pore size of about 0.05 to 0.1 μm, and the solid is removed. The filtrate of the solid separating device is fed to the reverse osmosis membrane device or the nanofiltration membrane device.

Since the adsorption capacity of the ion exchange resin or the activated carbon in the adsorption tower gradually decreases, the load of the reverse osmosis membrane device on the downstream side tends to vary. Also it is difficult to efficiently remove the pigment ingredient in the saccharified solution by the adsorption treatment by the ion exchange resin or the activated carbon, and fouling tends to occur in the reverse osmosis membrane device.

### Example

Bagasse as biomass was micronized to have a mean particle size of 1 mm or less, and the saccharification step was conducted by the hydrolysis method using high temperature and high pressure water in a subcritical state. The solid in the obtained saccharified solution was separated by using quantitative filter paper No. 5C. The saccharified solution after separation of the solid was fed to the membrane separator having a ultrafiltration membrane having a nominal molecular cutoff of 6000 to conduct a filtration step. The filtrate of this membrane separator was fed to the reverse osmosis membrane device having a reverse osmosis membrane device having an effective area of 32 cm² to measure the flux.

### Comparative Example

To the saccharified solution that is identical to that of Example, particulate activated carbon for sewage treatment having a mean particle size of 1 mm was added in an amount of 2.5% by mass to the mass of the saccharified solution, and stirred overnight. After end of the stirring, the solution was left still for 10 minutes, and the supernatant, saccharified solution was subjected to the filtration step using a filter device (solid separating device) having a membrane filter with a nominal pore size of 0.45 μm. The filtrate of the filter device was fed to the reverse osmosis membrane device in the same condition as in Example.

<Change in Transmission Flow Rate of Reverse Osmosis Membrane>

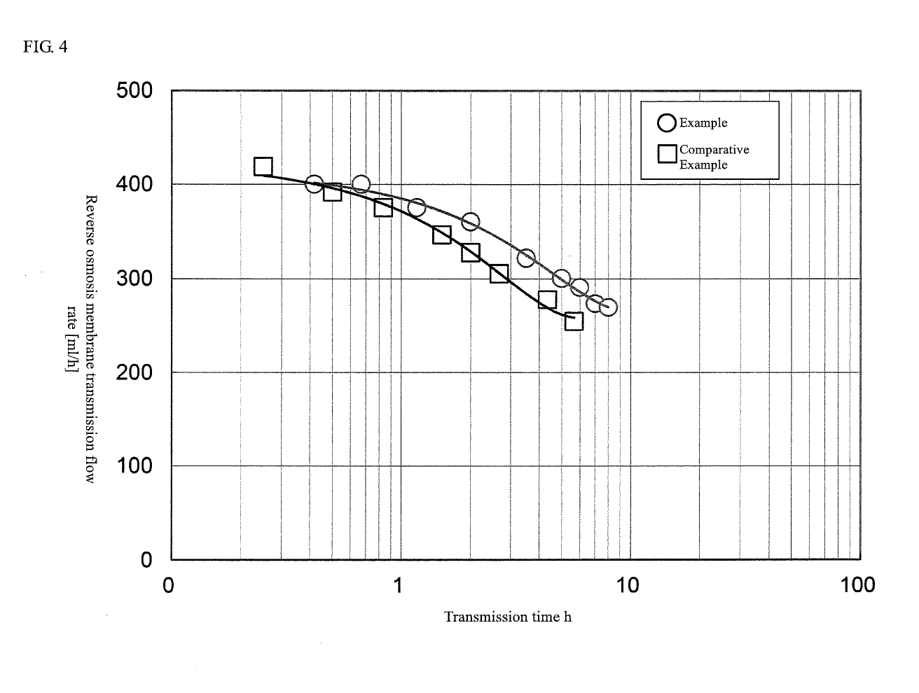

For Example and Comparative Example, the transmission flow rate of the reverse osmosis membrane was measured over time. FIG. 4 is a graph plotting the relationship between the transmission time (operation time) and the transmission flow rate of the reverse osmosis membrane. FIG. 4 reveals that the reduction in the transmission flow rate of the reverse osmosis membrane is smaller and occurrence of fouling is suppressed in Example in comparison with Comparative Example.

### INDUSTRIAL APPLICABILITY

The method for producing a concentrated saccharified solution of the present invention is useful in energy fields including a bioethanol production field.

1. A method for producing a concentrated saccharified solution, comprising:
a saccharification step of hydrolyzing cellulosic biomass to obtain a saccharified solution;
a filtration step of filtering the saccharified solution by a membrane separator; and
a concentration step of concentrating the filtered saccharified solution by a reverse osmosis membrane device or a nanofiltration membrane device;
wherein the membrane separator is a membrane separator having a separation membrane of a molecular cutoff ranging from 1000 or more and 7000 or less, and
the filtration step is a step of feeding a filtrate of the membrane separator to the reverse osmosis membrane device or the nanofiltration membrane device.
